(19) United States
(12) Patent Application Publication
(10) Pub. No.: US 2010/0255915 A1
(43) Pub. Date: Oct. 7, 2010

(54) Portable control for computer flight simulators

(76) Inventor: David Russell Spradley, Playa del Rey, CA (US)

Correspondence Address: David Russell Spradley, 8200 Redlands St., #216, Playa del Rey, CA, 90293, US

(21) Appl. No.: 12/384,487

(22) Filed: Apr. 4, 2009

(51) Int. Cl. A63F 13/02

(52) U.S. Cl. 463/38

(57) ABSTRACT

A compact, portable joystick comprised of a sturdy base housing the electronics, removable joystick handle, and removable throttle handle. In addition, there is a USB port provided for a USB cable of appropriate length for the application. The removable joystick and throttle handles facilitates the portability of the unit for carrying in a standard laptop computer bag. The portable control system can be assembled in seconds, and can be placed next to, or on top of, the laptop computer for flight simulation or other gaming applications in a very confined environment as in a commercial aircraft seat. In addition to axis and throttle control, several buttons are provided to assign to various tasks within the flight simulator or gaming software.

### CROSS-REFERENCE TO RELATED APPLICATIONS

Not applicable.

### FIELD OF THE INVENTION

The invention relates to a portable control system designed to operate the axis and throttle of computer simulations, and more particularly to flight simulators. Although there are several flight controllers and joysticks as prior art, none have the specific features necessary to portability as it relates to traveling with and storage in a small area.

### BACKGROUND OF THE INVENTION.

Joysticks have been around since the earliest days of personal computer based flight simulators. More recently, yokes, rudder pedals, and separate throttle and joystick combinations: “HOTAS” (Hands On Throttle And Stick), external LED and button modules, have been introduced and continue to increase the realism of the flight simulation. All of these advancements do indeed increase the realism of the desktop simulator, but what are the options if one wants to use a laptop computer for flight simulation while traveling? Since the large size of joysticks and even larger yokes preclude carrying them in all but the largest bags, small video game controllers, “gamepads” are another option, but leave much to be desired. By having such small “top hat” style joysticks, even small movements translate into very large control deflections in the simulation. Also there is no throttle, meaning buttons must be assigned to this function and there is no way to immediately perceive where the throttle is set. As any pilot will tell you, aircraft attitude, especially on approach, is controlled by precise inputs of pitch and power. These small gamepads make it very difficult to precisely maneuver a virtual aircraft. What is needed is a small controller that easily fits in a standard sized laptop bag that accurately emulates the necessary controls to operate virtual aircraft. The controller needs to be small enough to sit either directly on the laptop computer or next to it and occupy a very small footprint. The throttle and joystick controls need to realistically mirror the real controls both in operation and sensitivity. Any assembly and setup required should be able to be accomplished in seconds, and the serial connection needs to be as universal to all computers as possible.

### SUMMARY OF THE INVENTION

Accordingly, the present invention combines the best attributes of both the full size joysticks and smaller gamepads into one unit that is flight simulator specific, yet easily fits in a standard laptop carrying bag. The present invention has instantly recognizable controls, is easy to set up, and allows accurate flight simulation in a surprisingly compact package. The present invention has user assignable buttons for autopilot controls, flaps, trim, landing gear, etc. Flight control sensitivity is customizable in software for user preference and aircraft type. A USB port, allowing custom sized cables to be used, is available so the user doesn't have to coil up cable that isn't being used, yet can utilize a longer cable if desired. The USB interface allows that the controller can be connected and disconnected without concern as to the power status of the computer. The housing of the unit provides a sturdy base for the controls that provides a good balance of portability and weight. The bottom utilizes a non-skid, non-marring material to prevent slipping and damaging the table or laptop computer surface. The present invention also contains a data management system consisting of a processor, actuators, memory, contact sensors and communication bus to relay information to the computer. The USB connection is made via a USB port on the housing rather than a hard-wired cable to facilitate the use of a cable of the appropriate length, thereby eliminating the need to manage excess cable. It is an object of the invention to provide a secure base for the controls and allow accurate inputs of information for the software to process. It is also an object of the invention to provide a realistic reflection of the virtual aircraft control surface response to user inputs. It is also an object of the invention to provide user assignable actions to take place in the software based on desired button presses on the base. It is also an object of the invention to have plug and play capability for use directly out of the box with no programming or driver installation necessary, and to be able to connect or disconnect from the computer without regard to power status.

### BRIEF DESCRIPTION OF THE DRAWINGS

The above objects, and other characteristics, advantages, functions and features will become apparent upon consideration of the following description and claims and reference to the accompanying drawings. The drawings contain all parts wherein reference numbers designate corresponding parts in the various figures wherein:

FIG. 1 is an exploded view showing all components and their relative position as designed.

FIG. 2 is a perspective view of the unit in its intended configuration for use.

FIG. 3 is a perspective view of the unit as it relates to a typical laptop computer when in use.

FIG. 4 is a front view of the unit in its disassembled form for storage and transport, showing all components necessary for use.

### DETAILED DESCRIPTION OF THE INVENTION

In the following detailed description of the preferred embodiment, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that structural, logical, and electronic changes may be made without departing from the spirit and scope of the present invention.

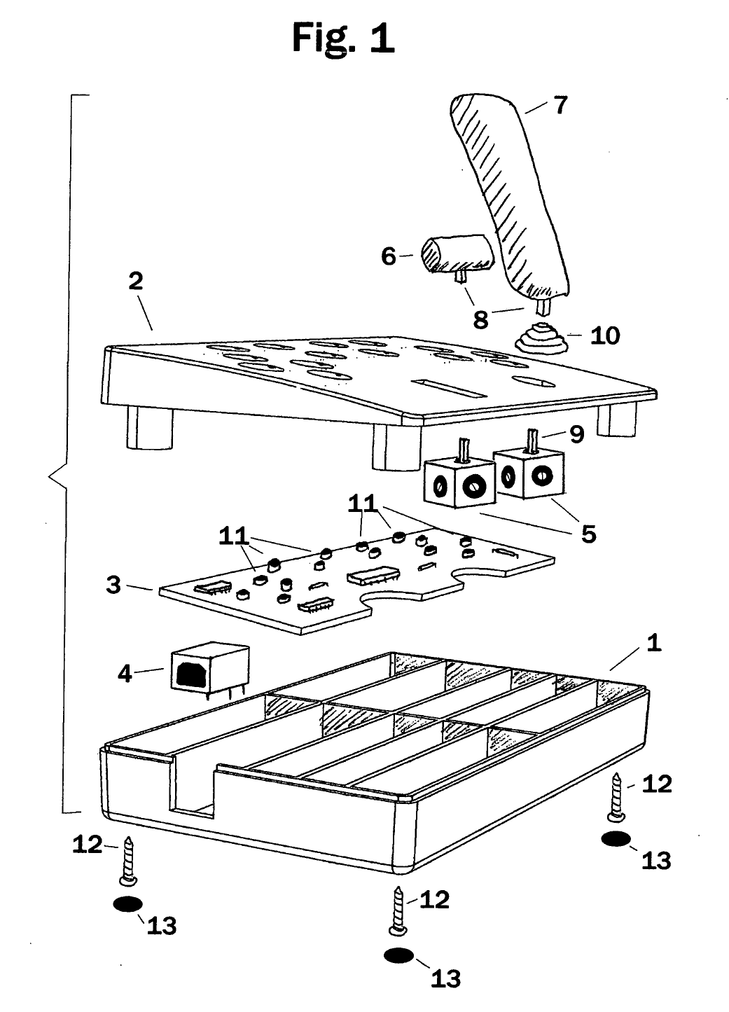

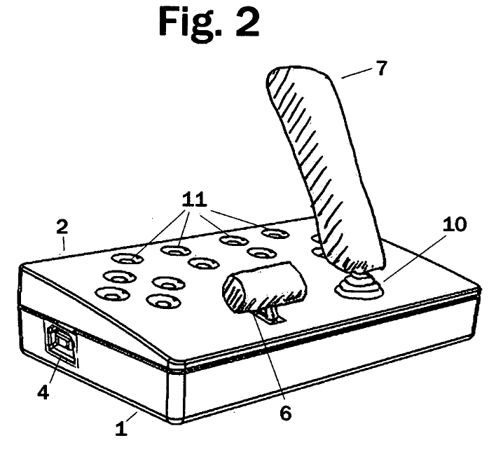

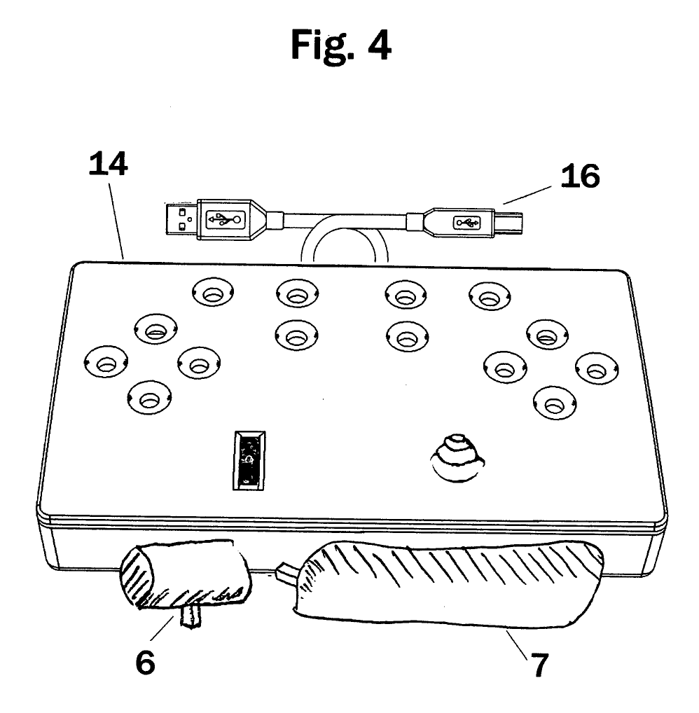

As shown in the exploded view of FIG. 1, the invention generally consists of a lower housing 1 which provides a solid platform for the unit as well as an enclosure for the circuit board 3, USB port 4, joystick and throttle actuators 5. The upper housing 2 secures the lower housing and electronics and provides openings for carbon puck switches 11, high strength brass male couplings 9, and dust boot 10. The assembly is secured using screws 12, which are covered by low profile non skid feet 13. The unit is assembled by sliding the throttle handle 6 and the joystick handle 7 onto the high strength brass male coupling 9 via the high strength female brass coupling 8. The assembled unit is represented in FIG. 2, showing the relative relationship of all parts when assembled. The only assembly required for regular use is the sliding of the joystick 7 and throttle handle 6 into place. Disassembly for storage and transport is the reverse, by removing the USB cable 16, throttle handle 6, and joystick 7, and reduces the vertical size of the unit significantly. FIG. 4 shows the present invention in its disassembled form, ready for transport or storage.

The upper and lower housings 1, 2 are constructed of high impact plastic or aluminum, depending on the desired strength of the invention. The joystick 7 and throttle handle 6 are constructed of high impact plastic, wood, composites, or aluminum, or a combination of these materials. Changing of the construction materials of these embodiments does not depart from the spirit or scope of the present invention.

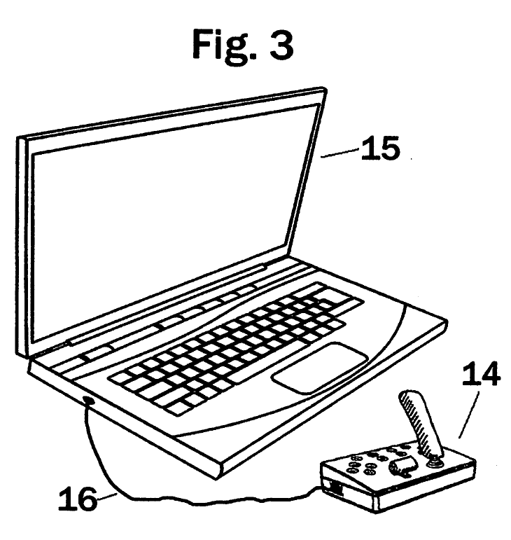

The circuit board 3 contains the contact points for the carbon puck switches 11, solder points for the wiring for actuators 5, solder points for the wiring for USB port 4, and such electronic components and processors as necessary to facilitate communication with the computer 15. This communication of control inputs is transmitted to the computer via the universal serial port (USB) 4, and USB cable 16. FIG. 3 illustrates the relationship between the Portable Flight Control 14, the USB cable 16, and the computer 15.

The joystick actuators 5 are either spring loaded to return to center when released joystick), or free to remain in the last used position (throttle). This is accomplished be omitting the return spring in the throttle actuator. The carbon puck buttons 11 are matched to contact points on the circuit board 3, providing user assignable inputs for autopilot, landing gear position, flap position, view, trim, etc. In addition to the 14 carbon puck buttons 11, each actuator 5 has a button integral to the unit that contacts when the joystick or throttle handle is pushed down. These actuator switches provide 2 additional user assignable inputs for guns, view centering, reverse thrust, etc.

As an option, one or more accessory ports may be provided for external input of control forces, providing for rudder pedals, helicopter collective, additional throttles, etc.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form function and manner of operation, assembly and use, are deemed readily apparent and obvious to those skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What I claim as my invention is:

1. A. A portable flight control system comprising:
A base with enclosed electronics
Assignable buttons
Detachable joystick and throttle handles
USB port
B. The portable flight control system of claim 1, wherein the base contains the necessary processor for converting joystick and throttle motion into data the computer can use to control virtual aircraft control surfaces.
C. The portable flight control system of claim 1, wherein the base contains the necessary processor for converting button presses into data the computer can use to perform the actions assigned to those buttons.
D. The portable flight control system of claim 1, wherein the base contains high strength brass couplings to facilitate mounting of detachable joystick and throttle handles.
E. The portable flight control system of claim 1, wherein the base has non-skid feet.
F. The portable flight control system of claim 1, wherein the base provides a USB port to facilitate connection to computer.
G. The portable flight control system of claim 1, wherein the detachable joystick and throttle each contain a high strength brass coupling to facilitate mounting to the base.
H. The portable flight control system of claim 1, wherein the detachable handles and removable USB cable make the device small enough to fit in a standard laptop carrying case with the laptop computer inside.
I. A method of the user of the portable flight control system of claim 1 providing the inputs necessary to control virtual aircraft in a flight simulator program.
J. The method of claim 9, further comprising moving aircraft control surfaces using inputs of joystick movement.
K. The method of claim 9 further comprising controlling the aircraft engine speed using inputs of the throttle movement.
L. The method of claim 9.further comprising the operation of aircraft systems using the button inputs.
M. The method of claim 12 further comprising the depressing of the joystick and throttle.
N. The method of storing the portable flight control system of claim 1.
O. The method of claim 14 further comprising the removal of the joystick and throttle handles.
P. The method of claim 14 further comprising the removal of the USB cable.
Q. An apparatus comprising:
A processor;
A Human Interface Device (HID) coupled to the processor;
User assignable switches coupled to the HID;
A detachable joystick and throttle coupled to the HID.
